(19) United States
(12) Patent Application Publication
(10) Pub. No.: US 2026/0195036 A1
(43) Pub. Date: Jul. 9, 2026

(54) METHOD AND APPARATUS FOR CONTROLLING VEHICLE FUNCTION BY A SEAT

(71) Applicant: HYUNDAI AUTOEVER CORP., Seoul (KR)

(72) Inventors: Gang Seok Suh, Seoul (KR); Jung Eun Kim, Seoul (KR); Jin Young Han, Seoul (KR); Moon Jeong Kim, Seoul (KR); Won Heung Jo, Seoul (KR)

(73) Assignee: HYUNDAI AUTOEVER CORP., Seoul (KR)

(21) Appl. No.: 19/416,665

(22) Filed: Dec. 11, 2025

(30) Foreign Application Priority Data
Jan. 3, 2025 (KR) 10-2025-0000773

(51) Int. Cl. G06F 3/0488; B60K 35/10; B60N 2/02; G06F 3/04842; G06F 3/04847

(52) U.S. Cl. CPC G06F 3/0488; G06F 3/04842; G06F 3/04847; B60K 35/10; B60K 2360/1438; B60N 2/0233

(57) ABSTRACT

A method for controlling a vehicle function by seat includes displaying, on a touch display of the computing device, a first screen for controlling a first function by seat in a vehicle, wherein the first screen includes a first object representing a first seat of the vehicle and a second object representing at least one second seat of the vehicle. The method also includes, in response to input of a touch-drag gesture moving from the first object to the second object, determining the first seat as a reference seat and determining the at least one second seat as a selected seat. The method additionally includes setting a setting value for the first function of the selected seat to be a same value as a setting value for the first function of the reference seat.

### CROSS-REFERENCE TO RELATED APPLICATION

This application claims the benefit of and priority to Korean Patent Application No. 10-2025-0000773, filed on Jan. 3, 2025, the entire contents of which are hereby incorporated herein by reference.

### TECHNICAL FIELD

The present disclosure relates to a method and apparatus for controlling a vehicle function by a seat.

### BACKGROUND

The statements in this section merely provide background information related to the present disclosure and may not constitute prior art.

Devices for controlling vehicle functions, such as air conditioning, seat control, and window control, may be controlled via a display user interface (UI) instead of physical buttons. A display UI may simplify interior vehicle design, maximize space utilization, and provide a digitalized user experience.

However, compared to conventional methods using physical buttons, controlling vehicle functions via a display UI may have limitations in terms of intuitiveness and ease of operation. For example, operating a display UI while driving may require the driver's visual attention, potentially compromising driving safety. In addition, issues such as slow UI response speed or low touch sensitivity may cause user inconvenience when controlling vehicle functions through a display UI.

### SUMMARY

Aspects of the present disclosure provide a technology that may enhance intuitiveness and ease of operation while controlling vehicle functions via a display UI.

Aspects of the present disclosure provide a technology that may reduce visual and physical load during driving and improve user experience.

Aspects of the present disclosure provide a method and apparatus for collectively controlling a vehicle function by a seat using a touch gesture on a display.

Aspects of the present disclosure provide a method and apparatus for selecting multiple seats for vehicle function control using a touch gesture on a display.

Aspects of the present disclosure provide a method and apparatus for controlling a vehicle function through a display UI that is intuitive and easy to operate.

The objectives of the present disclosure are not limited to those mentioned above. Other objectives not explicitly stated herein should be more clearly understood by those having ordinary skill in the art based on the following description.

According to an aspect of the present disclosure, a method for controlling vehicle function by a seat is provided. The method includes displaying, on a touch display of a computing device, a first screen for controlling a first function by a seat in a vehicle, the first screen being a screen that includes a first object representing a first seat of the vehicle and a second object representing at least one second seat of the vehicle. The method also includes, in response to input of a touch-drag gesture moving from the first object to the second object, determining the first seat as a reference seat and determining the at least one second seat as a selected seat. The method additionally includes setting a setting value for the first function of the selected seat to be the same as a setting value for the first function of the reference seat.

In some embodiments, determining the first seat as the reference seat and the at least one second seat as the selected seat includes, after receiving, from a user, a touch input on the first object for the touch-drag gesture, displaying the first object to be distinguishable from objects representing other seats of the vehicle different from the first seat, and after receiving, from the user, a touch input on the second object for the touch-drag gesture, displaying the second object to be distinguishable from objects representing other seats of the vehicle different from the at least one second seat.

In some embodiments, the method may further include, in response to input of a touch-drag gesture moving from the second object to a third object representing a third seat of the vehicle, additionally determining the third seat as a selected seat.

In some embodiments, setting the setting value for the first function of the selected seat to be the same as the setting value for the first function of the reference seat includes, after the selected seat has been determined, receiving, from a user, a predefined touch gesture for deselecting a selected seat, and setting the setting values for the first function of selected seats excluding the seat that has received the predefined touch gesture to be the same as the setting value for the first function of the reference seat.

In some embodiments, the method may further include displaying, on the touch display, a second screen for adjusting at least one setting value for the first function, the second screen being a screen displayed together with the first screen; receiving, from a user, a predefined touch gesture for adjusting the at least one setting value on the second screen; and in response to the predefined touch gesture on the second screen, adjusting the setting value for the first function of the reference seat and the setting value for the first function of the selected seat.

In some embodiments, the first screen is a screen that displays objects representing seats in the vehicle in accordance with a seat layout of the vehicle.

According to the aforementioned and other embodiments of the present disclosure, a method for controlling vehicle function by a seat is provided. The method includes displaying, on a touch display of the computing device, a first screen for controlling a first function by seat in a vehicle, the first screen being a screen that includes a first object representing a first seat of the vehicle and second objects representing a plurality of remaining seats of the vehicle. The method also includes, in response to a predefined touch gesture being input to the first object, determining the first seat as a reference seat and determining the plurality of remaining seats as selected seats. The method additionally includes setting values for the first function of the selected seats to be the same as a setting value for the first function of the reference seat.

In some embodiments, determining the plurality of remaining seats as the selected seats includes determining, as the selected seats, remaining seats, other than the first seat, where occupant presence is detected.

According to the aforementioned and other embodiments of the present disclosure, a method for controlling vehicle function by a seat. The method includes displaying, on a touch display of the computing device, a first screen for controlling a first function by seat in a vehicle, the first screen being a screen that includes a first object representing a first seat of the vehicle and a second object representing a second seat of the vehicle, the first seat and the second seat being seats other than a predefined reference seat. The method also includes, in response to a predefined touch gesture being input to the first object, determining the first seat as a selected seat. The method additionally includes setting a setting value for the first function of the selected seat to be the same as a setting value for the first function of the predefined reference seat.

It should be noted that the effects of the present disclosure are not limited to those described above. Other effects of the present disclosure not mentioned herein should be more clearly understood by those or ordinary skill in the art from the following description.

### BRIEF DESCRIPTION OF THE DRAWINGS

The above and other aspects and features of the present disclosure should become more apparent from the following detailed description taken in conjunction with the accompanying drawings, in which:

FIG. 1 is a configuration diagram illustrating the structure of an apparatus for controlling a vehicle function by seat according to an embodiment of the present disclosure;

FIG. 2 is a view of the apparatus for controlling a vehicle function by seat according to an embodiment of the present disclosure;

FIG. 3 is a flowchart illustrating a method for controlling a vehicle function by seat according to an embodiment of the present disclosure;

FIGS. 4-8 are diagrams illustrating example screens that may be displayed according to the method of FIG. 3;

FIG. 9 is a detailed flowchart for explaining some of the operations of the method of FIG. 3;

FIGS. 10-12 are diagrams illustrating example screens that may be displayed according to the method of FIG. 9;

FIG. 13 is a flowchart illustrating operations that may be performed following the method of FIG. 3;

FIGS. 14 and 15 are diagrams illustrating example screens that may be displayed according to the method of FIG. 13;

FIG. 16 is a flowchart illustrating a method for controlling a vehicle function by seat according to another embodiment of the present disclosure;

FIGS. 17-19 are diagrams illustrating example screens that may be displayed according to the method of FIG. 16;

FIG. 20 is a flowchart illustrating a method for controlling a vehicle function by seat according to yet another embodiment of the present disclosure;

FIGS. 21 and 22 are diagrams illustrating example screens that may be displayed according to the method of FIG. 20; and

FIG. 23 is a hardware configuration diagram of a computing device used in some embodiments of the present disclosure.

### DETAILED DESCRIPTION

Hereinafter, embodiments of the present disclosure are described in detail with reference to the accompanying drawings. Advantages and features of the present disclosure and methods of accomplishing the same should be more clearly understood more from the following detailed description taken in conjunction with the accompanying drawings. The present disclosure may, however, be embodied in many different forms and should not be construed as being limited to the embodiments set forth herein. Rather, these embodiments are provided to make the present disclosure thorough and complete and to fully convey the concept of the disclosure to those having ordinary skill in the art, and the present disclosure is defined only by the appended claims.

In adding reference numerals to the components of each drawing, it should be noted that the same reference numerals are assigned to the same components as much as possible even when the components are shown in different drawings. In addition, in describing the present disclosure, where it was determined that a detailed description of the related well-known configuration or function would obscure the gist of the present disclosure, the detailed description thereof has been omitted.

Unless otherwise defined, all terms used in the present specification (including technical and scientific terms) may be used in a sense that can be commonly understood by those having ordinary skill in the art. In addition, the terms defined in the commonly used dictionaries should not be ideally or excessively interpreted unless specifically defined otherwise herein. The terminology used herein is for the purpose of describing particular embodiments only and is not intended to be limiting of the disclosure. In this specification, the singular also includes the plural unless specifically stated otherwise in the phrase.

In addition, in the following description, terms such as first, second, A, B, (a), (b), can be used. These terms are used only to distinguish the components from other components, and the nature or order of the components is not limited by the terms. If a component is described as being “connected,” “coupled” or “contacted” to another component, that component may be directly connected to or contacted with the other component, but it should be understood that another component also may be “connected,” “coupled” or “contacted” between the components.

When a component, controller, device, element, apparatus, unit, or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, and the like may separately embody or be included with a processor and a memory, such as a non-transitory computer readable media, as part of the apparatus.

Hereinafter, embodiments of the present disclosure are described in detail with reference to the accompanying drawings.

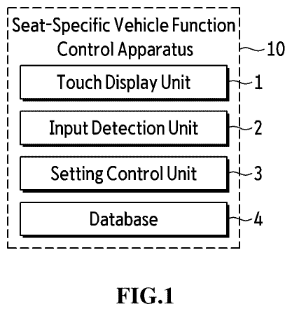

The configuration and operation of an apparatus (hereinafter, the seat-specific control apparatus) for controlling a vehicle function by a seat according to an embodiment of the present disclosure is described with reference to FIG. 1, which is a configuration diagram.

Referring to FIG. 1, a seat-specific control apparatus 10 according to an embodiment of the present disclosure may include at least one of a touch display unit 1, an input detection unit 2, a setting control unit 3, or a database 4.

The touch display unit 1 may display information on a vehicle function. In addition, a user (hereinafter, “the user”) of the seat-specific control apparatus 10 may input information on vehicle function control through contact with the touch display unit 1. For example, the user may input a selection of a seat for which the vehicle function is to be controlled. The user may also input a setting value (also sometimes referred to as “parameter value”) for controlling the vehicle function (e.g., cabin temperature, vehicle air conditioner's air volume (i.e., the intensity of the air), vehicle air conditioner's airflow direction, or speaker volume). In embodiments, the term “input” may include touch, draw, and swipe actions on the touch display unit 1.

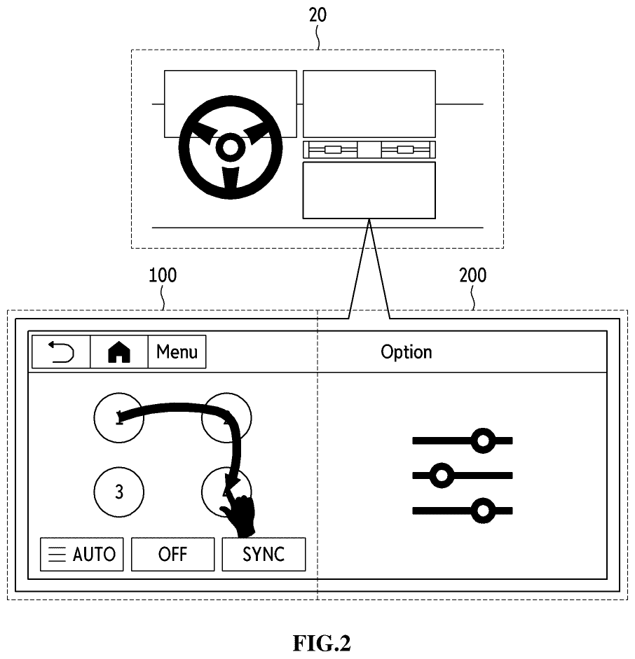

For example, referring to FIG. 2, the touch display unit 1 may be included in a display provided inside a vehicle 20. The touch display unit 1 may include a first screen 100 that displays seats subject to vehicle function control, and a second screen 200 that allows input of specific setting values (sometimes referred to as “parameter values”) for vehicle function control.

The input detection unit 2 may detect a touch point generated by the user's touch on the touch display unit 1. In an embodiment, the input detection unit 2 may detect when the touch point moves into a specific area displayed on the touch display unit 1. For example, when areas corresponding to seats within the vehicle 20 are displayed on the touch display unit 1, and the touch point moves into the areas, the input detection unit 2 may detect that the touch point has moved into the areas. In an embodiment, the seats corresponding to the areas into which the touch point has moved may be determined as target seats selected for vehicle function control.

For example, referring to FIG. 2, the user may touch the first screen 100 to select one or more target seats for which vehicle function control is to be performed. In an embodiment, the input detection unit 2 may detect the user's touch and determine the selected target seats. For example, the input detection unit 2 may detect that the touch point has moved into areas corresponding to the first, second, and fourth seats within the vehicle 20, and determine that the first, second, and fourth seats have been selected for vehicle function control, while the third seat has not been selected.

The setting control unit 3 may adjust a vehicle function setting value using the information input by the user. For example, if the user inputs vehicle function setting value information to set speaker volume to 100%, the setting control unit 3 may adjust the speaker volume to 100%. In an embodiment, the setting control unit 3 may adjust only the vehicle function setting values of the selected target seats. For example, if the user inputs vehicle function setting value information to set the speaker volume to 100% for only the driver's seat and the front passenger seat, the setting control unit 3 may adjust the speaker volume to 100% for only the driver's seat and the front passenger seat and may not adjust the speaker volume for the remaining seats.

The database 4 may store information regarding operations of the seat-specific control apparatus 10. For example, the database 4 may temporarily store the seats selected by the user for vehicle function control. In addition, the database 4 may store a pre-designated seat as a basis for vehicle function control. For example, if the user sets the driver's seat in advance as a reference for speaker volume, and then selects a seat other than the driver's seat while driving, the speaker volume of the selected seat may be changed to match that of the driver's seat.

Thus far, the components of the seat-specific control apparatus 10 have been described with reference to FIGS. 1 and 2. However, it is noted that the operations of the components of the seat-specific control apparatus 10 are not limited to the aforementioned examples and may include operations related to methods (hereinafter, the seat-specific control methods) for controlling a vehicle function by seat according to some embodiments of the present disclosure, which is described in more detail below. Furthermore, the technical ideas that may be understood from the following embodiments may be incorporated into the above-described seat-specific control apparatus 10, even if not separately stated.

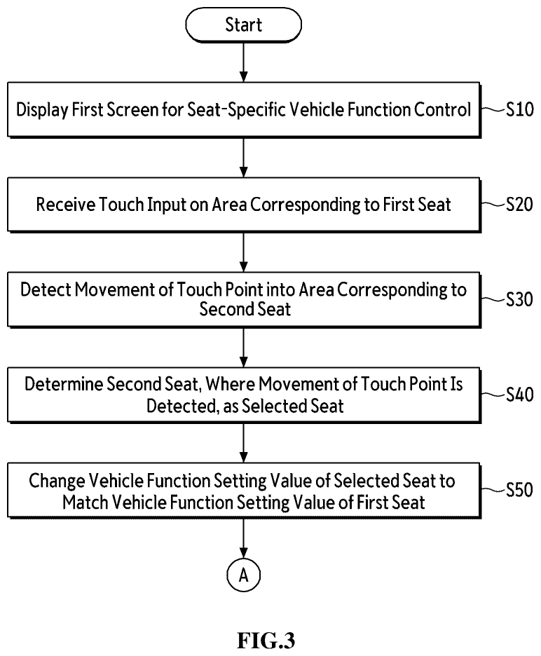

FIG. 3 is a flowchart illustrating a seat-specific control method according to an embodiment of the present disclosure. The seat-specific control method according to an embodiment of the present disclosure is described in more detail below with reference to FIG. 3.

The seat-specific control method according to an embodiment of the present disclosure may be performed by one or more computing devices. For example, the seat-specific control method according to an embodiment of the present disclosure may be implemented by two or more computing devices. Some steps or operations included in the seat-specific control method according to an embodiment of the present disclosure may be performed by a first computing device, while the remaining steps or operations may be performed by a second computing device.

The term “computing device” may refer to a computing device provided in a vehicle in which the seat-specific control apparatus 10 described with reference to FIG. 1 operates, or a computing device separate from the vehicle. In the following description, the subject of a particular step or operation may be omitted, in which case, it may be understood that the particular step or operation is performed by a computing device.

Referring to FIG. 3, in an operation S10, a first screen for controlling a vehicle function by seat may be displayed on a touch display (hereinafter referred to as “the display”) of a computing device. The first screen may be a screen on which objects representing the seats within a vehicle are displayed. For example, the objects may be icons representing the seats as viewed from above.

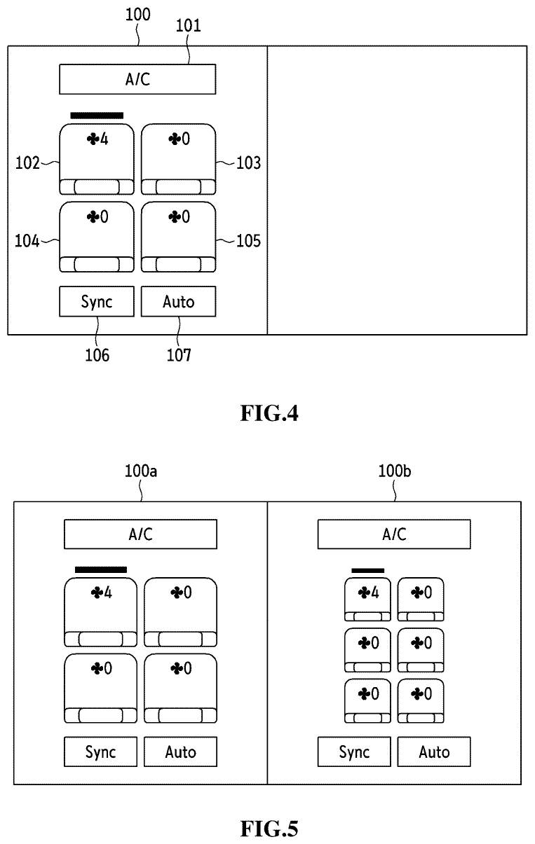

As one example, referring to FIG. 4, a first screen 100 for controlling a vehicle function by seat may be displayed on the display. A vehicle function type 101 to be controlled via the first screen 100 (e.g., air conditioning, heating, seat backrest angle, seat heater, ventilated seat, window open/close, window height, vehicle speakers, or vehicle displays) may be displayed. In FIG. 4, “A/C” represents air conditioning, the vehicle function to be controlled via the first screen 100. Additionally, icons indicating seats 102, 103, 104, and 105 within the vehicle, which are subject to vehicle function control, may be displayed on the first screen 100. The seats 102, 103, 104, and 105 may represent the driver's seat, the front passenger seat, the left rear seat, and the right rear seat, respectively. Also, buttons related to the vehicle function, such as a button 106 for integrated vehicle function control and a button 107 for automatic vehicle function control, may be displayed on the first screen 100. In the following description, for convenience, the terms “seat” and “object representing the seat” may be used interchangeably.

In one embodiment, the first screen may be a screen displaying areas corresponding to the seats within the vehicle according to the seat layout of the vehicle. For example, referring to FIG. 5, in a vehicle with four seats, four objects representing the four seats may be displayed on a first screen 100a. Additionally, the arrangement of the four objects may match the actual seat layout in the vehicle, such that the driver's seat and front passenger seat are positioned in the front and the left and right rear seats in the back. Conversely, in a vehicle with six seats, six objects representing the six seats may be displayed on a first screen 100b. Here, the arrangement of the six objects may also match the actual seat layout in the vehicle.

In an operation S20, the display showing the first screen may receive a touch input from the user within an area corresponding to a first seat of the vehicle. The area corresponding to the first seat may be displayed as an object representing the first seat on the first screen.

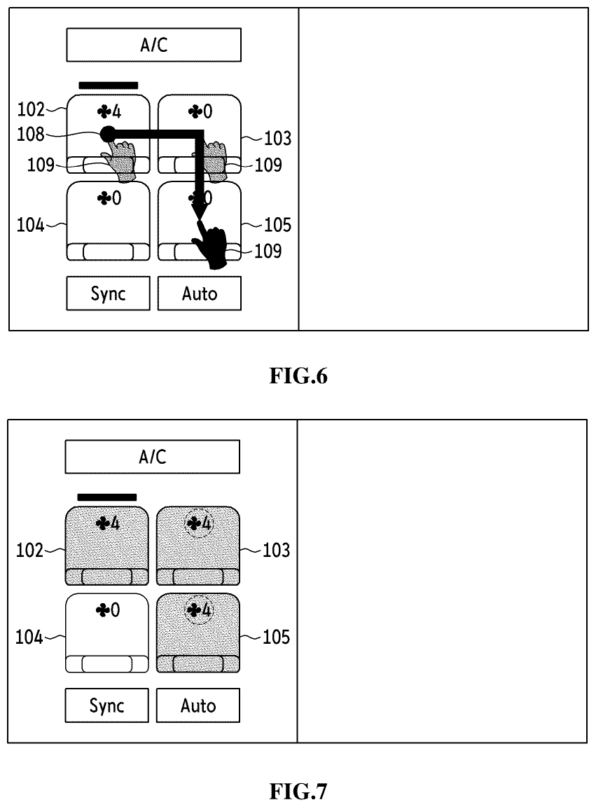

For example, referring to FIG. 6, the user may input a touch 109 within the area corresponding to the driver's seat 102. The driver's seat 102 may be determined as the first seat based on the touch 109. Also, the touch 109 may generate a touch point 108. The touch point 108 may exist until the user ends the touch 109 by lifting contact from the display.

In an operation S30, it may be detected that the touch point moves into an area corresponding to at least one second seat. The second seat may be a seat different from the first seat. Also, there may be a plurality of second seats.

For example, referring to FIG. 6, the user may move the touch point 108 into the area corresponding to the front passenger seat 103 without terminating contact with the display, and it may be detected that the touch point 108 has moved into the area corresponding to the front passenger seat 103. Similarly, the user may move the touch point 108 into the area corresponding to the right rear seat 105 without terminating contact with the display, and it may be detected that the touch point 108 has moved into the area corresponding to the right rear seat 105.

In an operation S40, the second seat into which the touch point has moved may be determined as a selected seat. For example, referring to FIG. 6, if the user moves the touch point 108 into the area corresponding to the front passenger seat 103 and the area corresponding to the right rear seat 105, the front passenger seat 103 and the right rear seat 105 may be determined as selected seats. In addition, referring to FIG. 7, the object representing the first seat, i.e., the driver's seat 102, and the objects representing the selected seats, i.e., the front passenger seat 103 and the area corresponding to the right rear seat 105, may be displayed differently from the object representing an unselected seat, i.e., the left rear seat 104.

Accordingly, there may be more than one second seat. For example, after the touch point has moved into the area corresponding to the second seat, it may be detected that the touch point moves out of the area corresponding to the second seat. Then, it may be detected that the touch point moves into an area corresponding to a third seat, which is different from the first and second seats, without the touch point disappearing. When the contact between the user and the display terminates and the touch point disappears, the second and third seats may be determined as selected seats.

In an operation S50, the vehicle function setting values of the determined selected seats may be changed to the vehicle function setting value of the first seat. For example, referring to FIG. 7, if the air-conditioning setting value of the first seat is level 4, the air-conditioning setting values of the selected seats 103 and 105 may be changed from level 0 to level 4. Meanwhile, the air-conditioning setting value of the unselected seat 104 may remain unchanged at level 0.

The term “vehicle function” may refer to a function that can be adjusted differently for each seat. For example, the vehicle function may include seat heating, seat ventilation, seat recline adjustment, window control, seat-specific air conditioning control, seat-specific speaker control, or seat-specific display control. Also, the setting value or vehicle function setting value refers to a value defined to adjust or set the operating state or condition of the vehicle function according to the user's intent, and may be expressed as a numerical value, a level, or an ON/OFF state.

As one example, when the vehicle function is seat-specific air conditioning, the vehicle function setting value may be temperature (e.g., 18° C., 25° C., or 30° C.), airflow direction (e.g., upper, middle, or lower), or airflow intensity (e.g., level 1, 2, or 3). In another example, when the vehicle function is seat heating, the vehicle function setting value may be seat temperature (e.g., level 1, 2, or 3) or seat heating state (e.g., ON or OFF). In another example, when the vehicle function is seat ventilation, the vehicle function setting value may be ventilation intensity (e.g., high, medium, or low) or ventilation state (e.g., ON or OFF). In another example, when the vehicle function is seat-specific window control, the vehicle function setting value may be window height (e.g., 0%, 50%, or 100%). In another example, when the vehicle function is seat-specific display control, the vehicle function setting value may be display state (e.g., ON or OFF), display angle (e.g., high, medium, or low), or display brightness (e.g., level 1, 2, or 3). In another example, when the vehicle function is seat-specific speaker control, the vehicle function setting value may be speaker state (e.g., ON or OFF) or speaker volume level (e.g., 30%, 70%, or 100%).

Thus far, the seat-specific control method according to an embodiment of the present disclosure has been described with reference to FIGS. 3-7. According to this embodiment, based on a first seat touched and selected first, the vehicle function setting values of subsequently touched seats may be changed. Through this, the user's need to visually focus on the display to adjust specific vehicle function setting values may be reduced. As a result, the user may intuitively and easily control the vehicle function by seat through a touch-drag gesture moving from an object representing the first seat to an object representing a second seat.

For the convenience of explanation, this embodiment has been described using a touch-drag gesture as an example. However, it is noted that the user's touch gesture for selecting a reference seat and one or more selected seats is not limited to the touch-drag gesture. For example, the touch gesture may be multiple taps on an object representing each seat. The touch gesture may also include a long tap, swipe, pinch, and other touch gestures. That is, any predefined touch gesture may be treated as a gesture for selecting the reference seat and the selected seats.

As described above, when the touch point moves into an area corresponding to a seat displayed on the display, the seat may be understood as having been chosen as a selected seat. In the following description, when a seat is stated as being selected, it may be understood that the touch point has moved into an area corresponding to the seat. Also, in the following description, the terms “seat” and “area corresponding to the seat” may be used interchangeably. Therefore, the selection of a seat may be understood to mean that the touch point has moved into an area corresponding to the seat on the display.

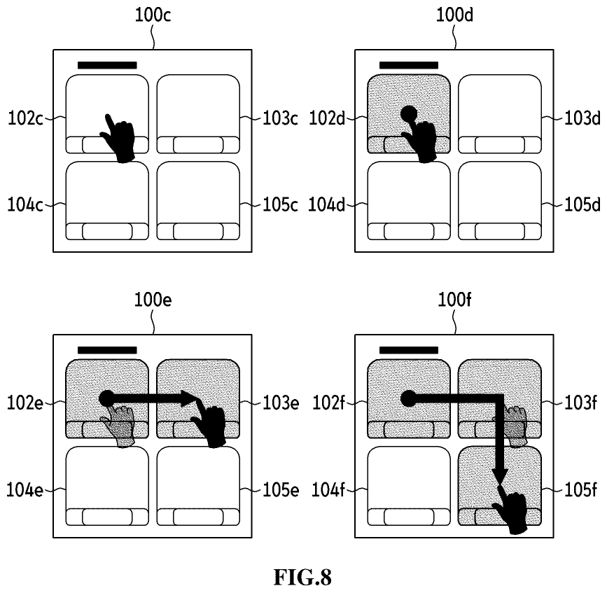

In the seat-specific control method according to an embodiment of the present disclosure, after seat selection is completed, a first seat and one or more selected seats may be displayed to be distinguishable from the remaining unselected seats. In one embodiment, even before the seat selection is completed, the first seat and selected seats chosen up to that point may be displayed in a distinguishable manner. This is described in more detail below with reference to FIG. 8.

When a touch is input within an area corresponding to the first seat, the area corresponding to the first seat and areas corresponding to other seats different from the first seat may be displayed in a distinguishable manner. For example, referring to FIG. 8, when a driver's seat 102c is selected on a first screen 100c as a first seat, a driver's seat 102d may be displayed on a first screen 100d to be displayed differently from other seats 103d, 104d, and 105d.

Thereafter, in response to detection of the movement of the touch point into an area corresponding to a second seat, the area into which the touch point has moved may be displayed in the same manner as the area corresponding to the first seat and in a distinguishable manner from the remaining seat areas. For example, referring to a first screen 100e of FIG. 8, when the touch point moves from an area corresponding to a driver's seat 102e to an area corresponding to a front passenger seat 103e, the front passenger seat 103e may also be displayed in the same manner as the driver's seat 102e. Furthermore, the front passenger seat 103e may be displayed in a distinguishable manner from seats other than the driver's seat 102e.

After moving into the area corresponding to the second seat, the touch point may further move into an area corresponding to a third seat, which is different from the first and second seats. In response to detection of the movement of the touch point into the area corresponding to the third seat, the area corresponding to the third seat may also be displayed in the same manner as the areas corresponding to the first and second seats, and in a distinguishable manner from the areas corresponding to the remaining seats.

In summary, when the user performs a touch or drag action to select one or more seats, the areas corresponding to the selected seats may be displayed differently to be visually distinguishable after selection. Through this embodiment, the user may clearly confirm the selected seats visually, thereby enhancing the intuitiveness and ease of use of the display for controlling a vehicle function.

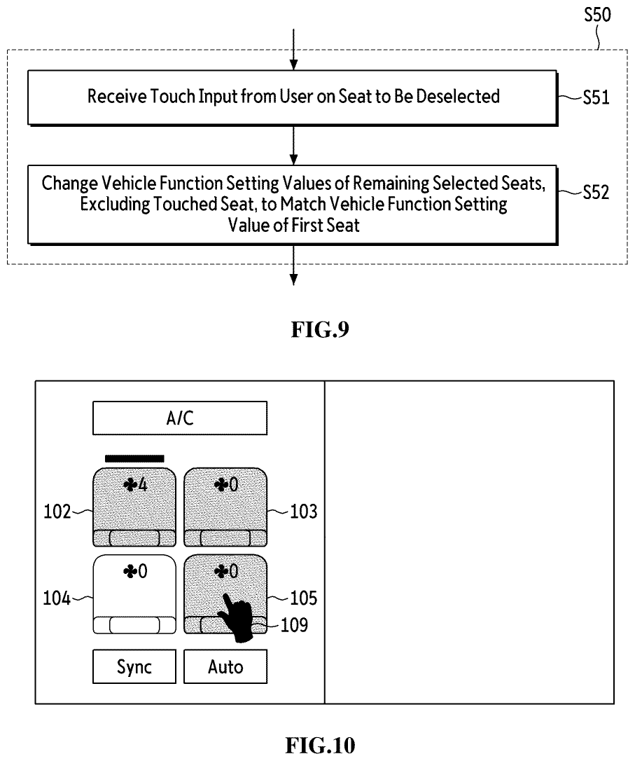

During the touch or drag action on the display, the user may mistakenly select an unintended seat. Therefore, in case the unintended seat is mistakenly selected, there is a need for a technique that allows the mistakenly selected seat to be deselected. Hereinafter, with reference to FIGS. 9-12, an operation for determining one or more selected seats while excluding some selected seats in the seat-specific control method according to an embodiment of the present disclosure is described in more detail.

Referring to FIG. 9, before the operation 50, which is the operation of changing the vehicle function setting values of the selected seats to the vehicle function setting value of the first seat, the display may receive an additional touch input from the user to designate a seat to be excluded from among the selected seats in an operation S51.

For example, referring to FIG. 10, the driver's seat 102 may be determined as the first seat, and the front passenger seat 103 and the right rear seat 105 may be determined as selected seats through touch and movement of the touch point. The determination of the first seat and selected seats may mean that the touch point has disappeared. Thereafter, after the first seat and selected seats are determined and before a predefined time elapses, the user may input a touch 109 to deselect the right rear seat 105. Specifically, the selection of the right rear seat 105 may have been user error or an operational mistake caused by vibration or impact during driving.

In an embodiment, the predefined time may be a period set in consideration of the possibility that the user may wish to deselect some of the selected seats. Once the predefined time elapses after the determination of the selected seats, the determination of the selected seats may be finalized.

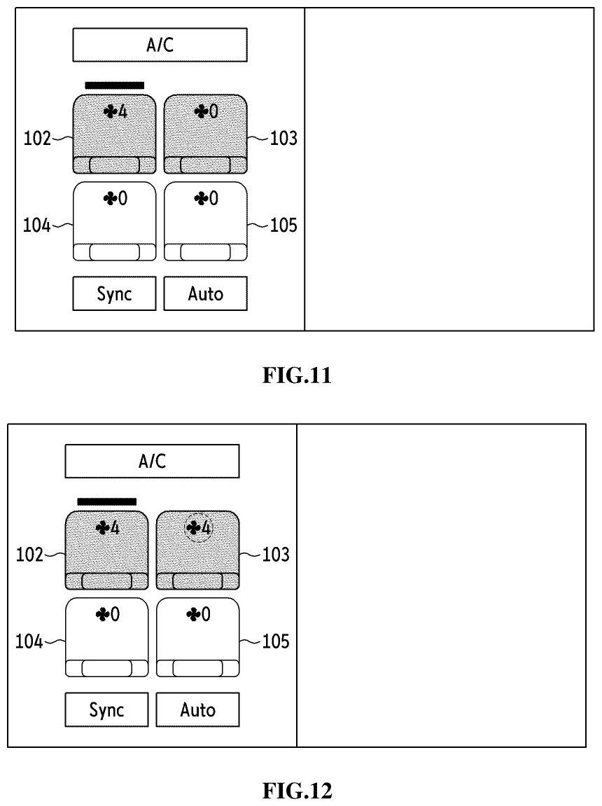

In one embodiment, referring to FIG. 11, after the touch 109 for excluding the right rear seat 105 from among the selected seats is completed, the right rear seat 105 may be displayed differently from the other selected seats, i.e., the driver's seat 102 and the front passenger seat 103. In addition, the right rear seat 105 may be displayed in the same manner as the left rear seat 104 which has not been selected.

Returning to FIG. 9, the seat that has received the additional touch input may be deselected. In an operation S52, the vehicle function setting values of all the selected seats except for the seat that has received the additional touch may be changed to that of the first seat. For example, referring to FIG. 12, the vehicle function setting value (e.g., air volume level 0) for the vehicle function (e.g., air conditioning) of the right rear seat 105 that has received the additional touch 109 may remain unchanged, and the vehicle function setting value (e.g., air volume level 4) of the front passenger seat 103 that has not receive the additional touch 109 may be changed to match the setting value (e.g., air volume level 4) of the first seat, i.e., the driver's seat 102.

In summary, after the selected seats are determined, the user may input an additional touch to deselect some of the selected seats. Through this embodiment, the user may deselect a seat that has been selected by mistake or operational error. Here, for the convenience of explanation, the action for deselecting a selected seat has been described as a touch or touch input, but it is noted that the user's action for deselecting one or more previously-selected seats is not particularly limited. For example, to deselect multiple selected seats, the user may perform a drag input to select multiple seats for exclusion almost in the same manner to choose multiple seats for selection.

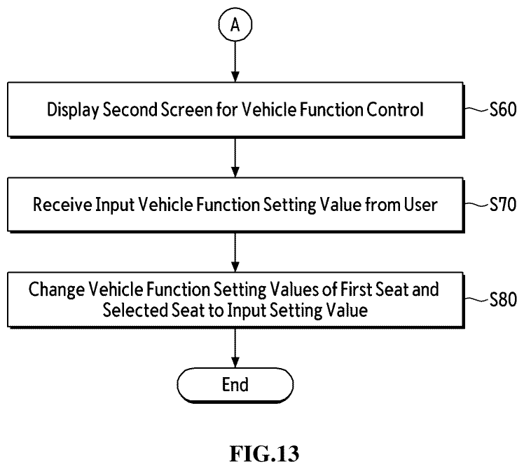

In an embodiment, for the first seat and the selected seats whose vehicle function setting values have been matched to that of the first seat, the user may wish to additionally change their vehicle function setting values collectively. Hereinafter, with reference to FIGS. 13-15, an operation for changing the vehicle function setting values of the first seat and selected seats collectively is described in more detail.

Referring to FIG. 13, in an operation S60, a second screen for adjusting a vehicle function setting value may be displayed on the display. In an embodiment, the second screen may be displayed adjacent to the first screen.

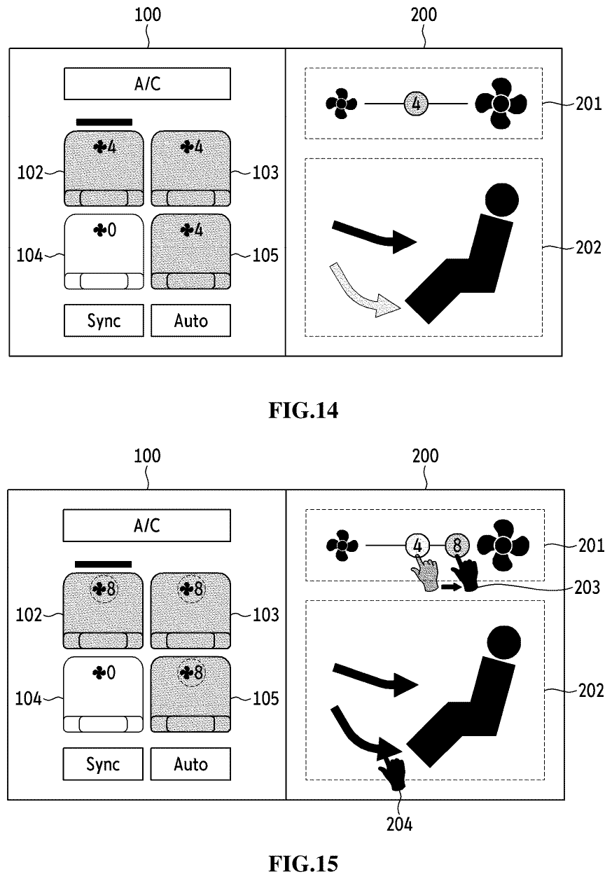

For example, referring to FIG. 14, a second screen 200 may be displayed adjacent to the first screen 100 on the display. The second screen 200 may include an indicator 201 for adjusting air volume, which is a setting value for air conditioning, and an indicator 202 for adjusting airflow direction, which is another setting value for air conditioning. The second screen 200 may display setting value information on the vehicle function currently being displayed on the display, i.e., air conditioning.

Returning to FIG. 13, in an operation S70, the display may receive a vehicle function setting value input from the user in connection with the second screen. In an embodiment, inputting a vehicle function setting value may include directly inputting a numerical value corresponding to the vehicle function setting value, or inputting the vehicle function setting value through interaction (e.g., touch, drag, or swipe) with elements displayed on the screen.

For example, referring to FIG. 15, the user may increase the air volume by performing a drag 203 on the indicator 201 for air volume adjustment. The user may also perform a touch 204 on the indicator 202 for airflow direction adjustment to add a direction for airflow output.

Returning to FIG. 13, in an operation S80, the vehicle function setting values of the first seat and the selected seats may be changed to the setting value input through the second screen. For example, referring to FIG. 15, the user may input “level 8” as an air volume setting value and “middle” and “lower” as airflow directions through the second screen. Then, the air conditioning setting values of the driver's seat 102, the front passenger seat 103, and the right rear seat 105 may be changed to the user-input setting values. Specifically, the air volumes of the driver's seat 102, the front passenger seat 103, and the right rear seat 105 may be changed to level 8, and the airflow directions of the driver's seat 102, the front passenger seat 103, and the right rear seat 105 may be changed to “middle” and “lower.”

In addition, information on some of the changed vehicle function setting values may be displayed on the first screen. For example, referring to FIG. 15, icons indicating the changed air volume level, for example, “level 8,” may be displayed within the areas corresponding to the driver's seat 102, the front passenger seat 103, and the right rear seat 105.

According to this embodiment, the user may collectively adjust the vehicle function for the first seat and the other selected seats. In particular, when the user has previously selected seats, it may be interpreted that the user intends to apply the same setting values to both the selected seats and the first seat. Therefore, by collectively adjusting the vehicle function for the selected seats and the first seat, a display UI matching the user's intention may be provided, and an intuitive and user-friendly operating environment may be achieved.

Thus far, an embodiment has been described in which, when multiple seats in the vehicle are selected on the display, the vehicle function setting values of the selected seats are changed based on the first selected seat. In some cases, in the process of collectively applying vehicle function control to certain seats of the vehicle, there may be cases where the first seat serving as a reference for vehicle function control may not necessarily be designated, or the subsequently selected seats may not necessarily be designated.

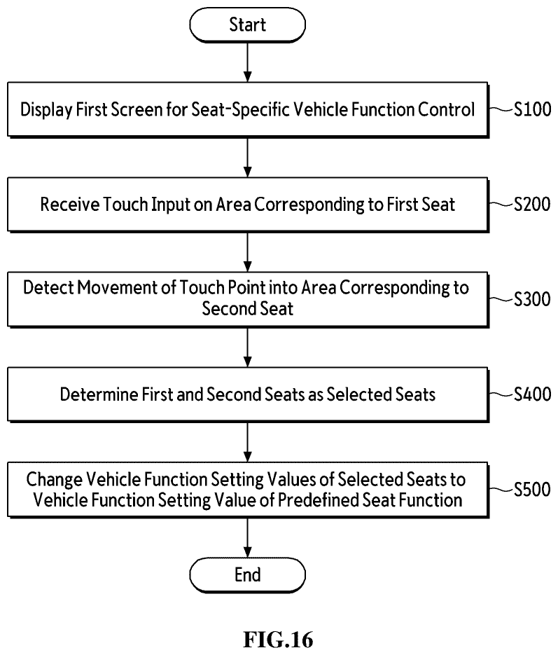

Hereinafter, with reference to FIGS. 16-19, a seat-specific control method is described in which only seats to be subject to update of vehicle function setting values are selected, without selecting a first seat as a reference for the vehicle function setting value update, according to an embodiment.

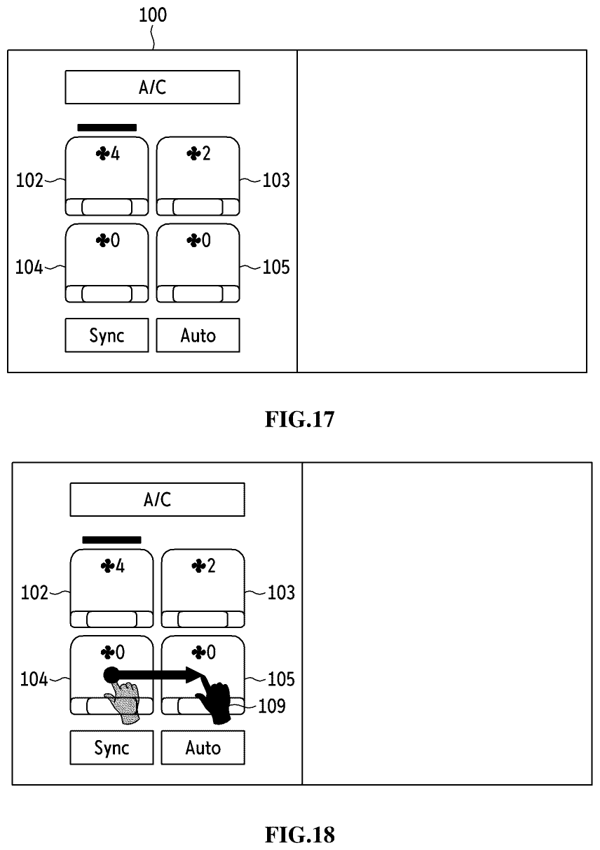

Referring to FIG. 16, in an operation S100, a first screen for controlling a vehicle function by seat may be displayed on a touch display of a computing device. The first screen may be a screen that displays seats of a vehicle. The first screen may be, for example, the same as the first screen described in some of the aforementioned embodiments of the present disclosure. For example, referring to FIG. 17, a first screen 100 may be displayed on a touch display. The first screen may include objects representing a driver's seat 102, a front passenger seat 103, a left rear seat 104, and a right rear seat 105.

In an operation S200, the touch display that displays the first screen may receive a touch input from the user within an area corresponding to a first seat of the vehicle. In an embodiment, there may be more than one first seat. For example, the user may select multiple first seats by touching the respective areas.

In an operation S300, it may be detected that a touch point, generated by the touch input within the area corresponding to the first seat, moves into an area corresponding to a second seat that is different from the first seat. For example, referring to FIG. 18, a touch 109 may be performed on the area corresponding to the left rear seat 104 to generate a touch point, and the touch point may then move into the area corresponding to the right rear seat 105.

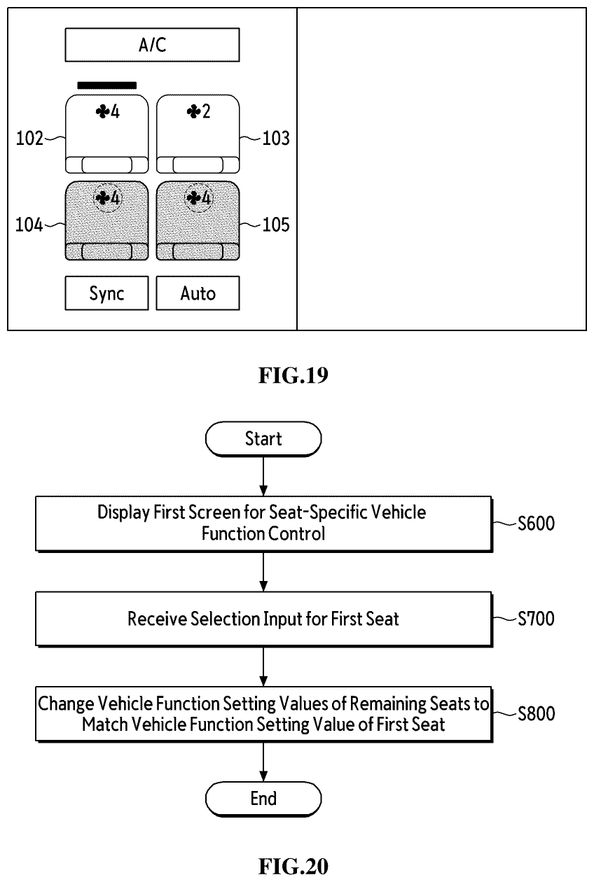

Returning to FIG. 16, in an operation S400, the first and second seats may be determined as selected seats. For example, referring to FIG. 19, the first seat (i.e., the left rear seat 104) and the second seat (i.e., the right rear seat 105) may be determined as selected seats, and the areas corresponding to the left rear seat 104 and the right rear seat 105 may be displayed to be distinguishable from the other non-selected seats 102 and 103.

In an operation S500, the vehicle function setting values of the first and second seats may be changed to the vehicle function setting value of a predefined seat of the vehicle. In an embodiment, the predefined seat of the vehicle may refer to a seat that has been designated as a reference for vehicle function control. For example, the user may designate the driver's seat as a reference seat prior to driving, and then selects and determines seats during driving, the vehicle function setting values of the selected seats may be matched to the vehicle function setting value of the driver's seat.

As one example, referring to FIG. 19, the user may designate the driver's seat 102 as a reference seat for air conditioner's air volume control. In this case, the air volumes of the selected seats, i.e., the left rear seat 104 and the right rear seat 105, may be changed from level 0 to level 4 to match the air volume of the driver's seat 102.

In summary, the user may designate in advance a seat such as the driver's seat as a reference seat for vehicle function control and may select seats to be subject to vehicle function control via a touch or drag input on the touch display, thereby easily performing vehicle function control by seat. Unlike in the previous embodiments, the user can easily perform vehicle function control by seat without needing to select a reference seat, thus improving the ease of operation for seat-specific vehicle function control.

In this embodiment, for ease of explanation, a case has been described in which multiple seats are selected via a touch and drag action, but the present disclosure is not limited thereto. Alternatively, a single seat, rather than multiple seats, may be selected, or yet alternatively, multiple seats may be selected through a touch action only, without a drag action. Additionally, by varying predefined touch gestures, an embodiment in which the user selects both a reference seat and selected seats via a touch gesture (e.g., a touch-drag gesture) and an embodiment in which the user chooses only selected seats via a touch gesture (e.g., a long tap followed by a touch-drag gesture) may both be implemented in a single device.

FIGS. 20-22 illustrate a seat-specific control method in which only a first seat that serves as a reference seat for vehicle function control is selected without selecting target seats for which vehicle function control is to be performed. Hereinafter, with reference to FIGS. 20-22, an embodiment in which only the first seat is selected is described in more detail.

Referring to FIG. 20, in an operation S600, a first screen for controlling a vehicle function by seat may be displayed on a touch display of a computing device. In an embodiment, the first screen may be a screen that displays the seats of a vehicle. For example, the first screen may be the same as the first screen described in some of the previously discussed embodiments of the present disclosure.

In an operation S700, the touch display that displays the first screen may receive a selection input from the user for a first seat of the vehicle. In an operation S800, the vehicle function setting values of the other seats of the vehicle may be changed to match the vehicle function setting value of the first seat.

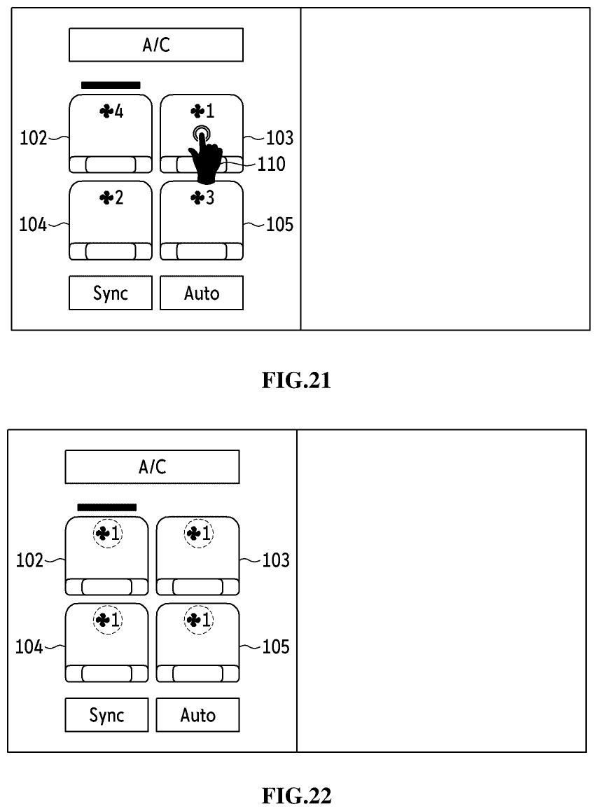

For example, referring to FIG. 21, the user may perform a double-tap 110 on an area corresponding to the front passenger seat 103. The double-tapped front passenger seat 103 may be determined as a first seat. Then, referring to FIG. 22, the air volume setting values of the other seats 102, 104, and 105 may be changed based on the front passenger seat 103. Here, the double-tap 110 is used to select the front passenger seat 103 as the first seat and is distinguished from the action for selecting the first seat, used in the previous embodiments. That is, the user's action for selecting the first seat, which is a reference seat for changing the vehicle function setting values of other seats, is not limited to the double-tap 110.

In one embodiment, the vehicle function setting values of not all the other seats than the first seat, but only seats where occupant presence has been detected, may be changed to the vehicle function setting value of the first seat. Accordingly, once the user selects the first seat, the setting values of only other seats where occupants are present may be changed.

In this embodiment, for the convenience of explanation, the reference seat may be selected via a double-tap, but the present disclosure is not limited thereto. Alternatively, the first seat may be selected by a long tap, and then, the vehicle function setting values of all the other seats may be changed. If the user touches the first seat and then performs a drag gesture without ending the touch, the vehicle function setting values of only the seats selected by the drag gesture may be changed.

In summary, when the user selects only the first seat for vehicle function control, seats with vehicle setting values to be updated may be automatically determined, thereby enabling seat-specific vehicle function control. Unlike in the previous embodiments, the user can perform vehicle function control by seat without needing to manually select target seats each time, thereby improving the ease of operation for such seat-specific vehicle function control.

As a result, in some embodiments, when the user selects seats within a vehicle, the vehicle function setting values of the selected seats may be controlled collectively, thereby significantly improving operational convenience. In particular, even in situations where it is difficult for the driver to visually focus on the display during driving, the driver can easily adjust a vehicle function by seat, thereby increasing both convenience and safety. In addition, since the UI of the display is designed to reflect the actual layout of the seats in the vehicle, the user can intuitively recognize which seat vehicle function control is being applied to and efficiently perform vehicle function

control in an intuitive manner. Furthermore, by using a display UI instead of physical buttons, the user can view all seat functions and relevant information at a glance.

The technical effects according to the inventive concept of the present disclosure are not limited to those mentioned above, and other effects not explicitly mentioned herein should also be clearly understood by those of ordinary skill in the art from the content of the present disclosure.

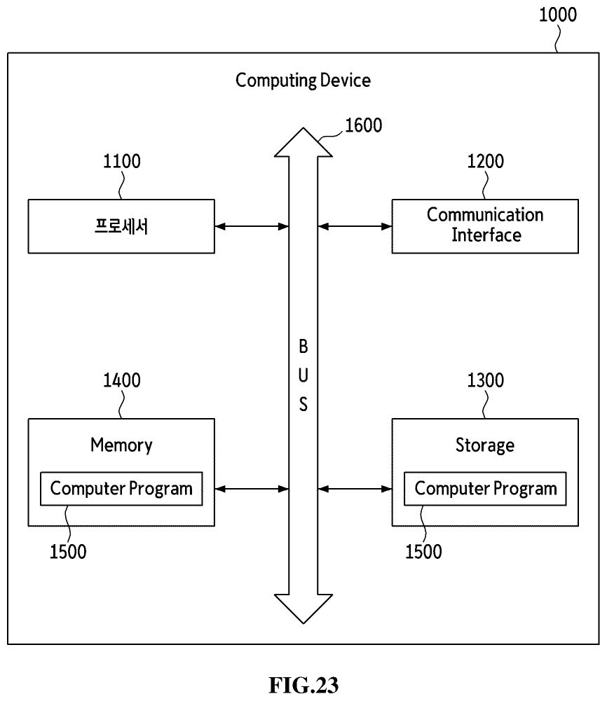

Hereinafter, with reference to FIG. 23, the hardware configuration of an example computing device according to some embodiments of the present disclosure is described in more detail. The computing device may be a navigation device or a computing device on which a navigation server is executed (e.g., a navigation terminal, computer, or smartphone).

FIG. 23 is an example hardware configuration diagram of a computing device that may implement various embodiments of the present disclosure. Referring to FIG. 23, a computing device 1000 may include at least one processor 1100, a system bus 1600, a communication interface 1200, a memory 1400 that loads a computer program 1500 executed by the processor 1100, and a storage 1300 that stores the computer program 1500. FIG. 23 illustrates only those components relevant to the embodiments of the present disclosure. Accordingly, one of ordinary skill in the art should recognize that additional general-purpose components not depicted in FIG. 23 may also be included.

For example, the computer program 1500 may include instructions for performing the operations of: displaying, on the touch display of the computing device 1000, a first screen for controlling a first vehicle function by seat in a vehicle, where the first screen includes a first object representing a first seat of the vehicle and a second object representing at least one second seat of the vehicle; in response to input of a touch-drag gesture moving from the first object to the second object, determining the first seat as a reference seat and the second seat as a selected seat; and setting the setting value for the first function of the selected seat to be the same as the setting value for the first function of the reference seat.

In another example, the computer program 1500 may include instructions for performing the operations of: displaying, on the touch display of the computing device 1000, a first screen for controlling a first vehicle function by seat in a vehicle, where the first screen includes a first object representing a first seat of the vehicle and second objects representing a plurality of remaining seats; in response to a predefined touch gesture being input to the first object, determining the first seat as a reference seat and the plurality of remaining seats as selected seats; and setting the setting values for the first function of the selected seats to be the same as that of the reference seat.

In yet another example, the computer program 1500 may include instructions for performing the operations of: displaying, on the touch display of the computing device 1000, a first screen for controlling a first vehicle function by seat in a vehicle, where the first screen includes a first object representing a first seat of the vehicle and a second object representing a second seat of the vehicle, and the first and second seats are seats other than a predefined reference seat; in response to a predefined touch gesture being input to the first object, determining the first seat as a selected seat; and setting the setting value for the first function of the selected seat to be the same as that of the predefined reference seat.

What is claimed is:

1. A method for controlling a vehicle function by seat, performed by a computing device, the method comprising:
displaying, on a touch display of the computing device, a first screen for controlling a first function by seat in a vehicle, wherein the first screen includes a first object representing a first seat of the vehicle and a second object representing at least one second seat of the vehicle;
in response to input of a touch-drag gesture moving from the first object to the second object, determining the first seat as a reference seat and determining the at least one second seat as a selected seat; and
setting a setting value for the first function of the selected seat to be a same value as a setting value for the first function of the reference seat.

2. The method of claim 1, wherein determining the first seat the reference seat and the at least one second seat as the selected seat includes:
after receiving, from a user, a touch input on the first object for the touch-drag gesture, displaying the first object to be distinguishable from objects representing other seats of the vehicle different from the first seat; and
after receiving, from the user, a touch input on the second object for the touch-drag gesture, displaying the second object to be distinguishable from objects representing other seats of the vehicle different from the at least one second seat.

3. The method of claim 1, further comprising, in response to input of a touch-drag gesture moving from the second object to a third object representing a third seat of the vehicle, additionally determining the third seat as a selected seat.

4. The method of claim 1, wherein setting the setting value for the first function of the selected seat to be the same value as the setting value for the first function of the reference seat includes:
after the selected seat has been determined, receiving, from a user, a predefined touch gesture for deselecting a selected seat; and
setting setting values for the first function of selected seats excluding the seat that has received the predefined touch gesture to be the same value as the setting value for the first function of the reference seat.

5. The method of claim 1, further comprising:
displaying, on the touch display, a second screen for adjusting at least one setting value for the first function, the second screen being displayed together with the first screen;
receiving, from a user, a predefined touch gesture for adjusting the at least one setting value on the second screen; and
in response to the predefined touch gesture on the second screen, adjusting the setting value for the first function of the reference seat and the setting value for the first function of the selected seat.

6. The method of claim 1, wherein the first screen is configured to display objects representing seats in the vehicle in accordance with a seat layout of the vehicle.

7. A method for controlling a vehicle function by seat, performed by a computing device, the method comprising:
displaying, on a touch display of the computing device, a first screen for controlling a first function by seat in a vehicle, wherein the first screen includes a first object representing a first seat of the vehicle and second objects representing a plurality of remaining seats of the vehicle;
in response to a predefined touch gesture being input to the first object, determining the first seat as a reference seat and determining the plurality of remaining seats as selected seats; and
setting setting values for the first function of the selected seats to be a same value as a setting value for the first function of the reference seat.

8. The method of claim 7, wherein determining the plurality of remaining seats as the selected seats includes determining, as the selected seats, remaining seats, other than the first seat, where occupant presence is detected.

9. A method for controlling a vehicle function by seat, performed by a computing device, the method comprising:
displaying, on a touch display of the computing device, a first screen for controlling a first function by seat in a vehicle, wherein the first screen includes a first object representing a first seat of the vehicle and a second object representing a second seat of the vehicle, the first seat and the second seat being seats other than a predefined reference seat;
in response to a predefined touch gesture being input to the first object, determining the first seat as a selected seat; and
setting a setting value for the first function of the selected seat to be a same value as a setting value for the first function of the predefined reference seat.
